(19) United States
(12) Patent Application Publication
(10) Pub. No.: US 2009/0278647 A1
(43) Pub. Date: Nov. 12, 2009

(54) INDUCTIVE DEVICES AND METHODS OF MAKING THE SAME

(76) Inventor: Harrie R. Buswell, Berea, KY (US)

Correspondence Address: MILES & STOCKBRIDGE PC, 1751 PINNACLE DRIVE, SUITE 500, MCLEAN, VA, 22102-3833, US

(21) Appl. No.: 12/161,544

(22) PCT Filed: Jan. 18, 2007
(86) PCT No.: PCT/US07/60722

§ 371 Date: Oct. 16, 2008

Related U.S. Application Data
(60) Provisional application No. 60/759,566, filed on Jan. 18, 2006.
(60) Provisional application No. 60/759,567, filed on Jan. 18, 2006.
(60) Provisional application No. 60/759,577, filed on Jan. 18, 2006.

(51) Int. Cl. H01F 27/30; H01F 27/24; H01F 7/127

(52) U.S. Cl. 336/182; 336/213; 29/605

(57) ABSTRACT

Toroidal inductive devices are manufactured with high efficiency through the use of bobbin winding techniques or wound magnetic pattern members.

### CROSS-REFERENCE TO RELATED APPLICATIONS

This application claims the benefit of U.S. Provisional Application No. 60/759,577, filed Jan. 18, 2006, entitled “Electrical Core Coils and Transformers and Processes For Making Same”; U.S. Provisional Application No. 60/759,567, filed Jan. 18, 2006, entitled “Inductive Devices and Process for Making Same”; and U.S. Provisional Application No. 60/759,566, filed Jan. 18, 2006, entitled “Inductive Devices and Process for Making Same,” each of which is incorporated herein by reference in its entirety.

### FIELD OF THE INVENTION

This invention relates generally to the field of electrical devices and, more specifically, to inductive devices and methods for making the same.

### BACKGROUND OF THE INVENTION

Conventional inductive devices, such as coils and transformers, have been used widely for over one hundred years. Inductive devices have applications in many areas of technology, including electric power distribution, motor and generators, power supplies, etc. Electric power distribution may include transformation, accomplished by inductive devices, at numerous points in a distribution system in order to effectively deliver electrical power from a generating source to an end user. Inductive devices constructed for lower frequency uses, such as electric power distribution, typically incorporate solid magnetic materials. While improvements in the magnetic material used in inductive devices have been made, these improvements typically have been incremental.

Conventional transformers can be generally categorized as one of three types: laminate core, wound core, and toroidal. Laminate core transformers are perhaps the most widely used and include a laminated sheet core of magnetic material around which the electrical coils are wound. Laminate core transformers include the so-called “E” and “I” core laminate devices, for example. Wound core devices include a magnetic core constructed of sheet stock. The wound core transformers are often used in electric power distribution applications. Toroidal transformers have been applied most often in applications below the size range typically needed for utility electric power distribution.

Toroidal type transformers and inductors often have many desirable operational characteristics, but tend to be more costly to manufacture than the other two types mentioned above. Also, the toroidal type devices have an inherent problem associated with heavy inrush currents, which can cause damage and failure to the inductive device or associated circuitry. The inrush current problem is primarily due to a lack of magnetic gap control in conventional toroidal type devices.

Conventional inductive device construction processes often involve the use of manual operations, especially related to the handling of the magnetic materials and the joining of the magnetic materials to the electrical conductor coils. Another common limitation relates to the use of geometries that perturb and distort magnetic fields present when the devices are in operation.

Laminate transformers and wound core transformers often require considerable handwork in manufacture. Conventional toroidal type devices also involve manual construction operations that, even with the aid of complex machines, render them expensive to manufacture. In some conventional devices, electrical windings are exposed to the environment, which can allow electromagnetic interference and flux losses from a conventional unit to the surrounding environment and can also subject the devices to external electromagnetic interference. Further, conventional device designs may exhibit aberrations of the magnetic flux pattern as a result of electrical conductors having magnetic components disposed unevenly about them. An uneven arrangement of magnetic material affects reluctance and perturbs flux pathways, thus also affecting the fundamental frequency and promoting undesirable harmonic activity.

### SUMMARY OF THE INVENTION

The present invention provides inductive devices and related manufacturing methods which have been conceived in light of the background discussed above.

In general, inductive devices and methods of making the same are disclosed. For example, the invention can be applied to coils, chokes, and/or transformers having electrical winding components constructed in a generally toroidal shape, where the electrical winding components constitute the physical core of the device. Magnetic components of wire or narrow strip material can be wound around the electrical core. Such magnetic components of wire or narrow strip (or a combination) can be wound to form multiple cylinders or splayed cylinders (i.e. sector shaped components) around the electrical core, with electrical component leads emanating from the device in such manner as to minimize obstruction of the magnetic components.

According to another aspect of the invention, an electrical coil is wound in an oblong configuration to form a cylindrical sector shaped coil. A plurality of such electrical coils can be assembled together in an essentially cylindrical shape to provide an inner “core” structure that can be bound together with magnetic wire or the like. The resulting structure is applicable to transformers and electric motor stators, for example.

According to another aspect of the invention, the magnetic component(s) of an inductive device can be formed from a serpentine or other wire pattern wound onto a mandrel, and a toroidal electrical core may be wound on the same mandrel, thus enabling toroidal inductive devices to be easily assembled on a simple manufacturing apparatus.

The following are exemplary of a number of particular aspects of the invention.

A. A method of forming an inductive device, including providing an electrical winding having a substantially toroidal shape and a bobbin disposed about the electrical winding, attaching magnetic material to the bobbin, and winding the magnetic material onto the bobbin, and thereby about the electrical winding, by rotating the bobbin about the electrical winding.

B. An inductive device having an electrical coil formed in a generally elongated toroidal configuration, and a magnetic component disposed about the electrical coil along an elongation direction and wrapped transversely to an electrical winding direction of the electrical coil without passing through an inner opening of the electrical coil.

C. An inductive device having an electrical winding having a substantially toroidal shape, a plurality of bobbins, each placed about the electrical winding and circumferentially offset from each other, and a plurality of magnetic components, each wound onto a corresponding one of the plurality of bobbins, wherein at least one of the plurality of magnetic components includes a plurality of discrete magnetic subcomponents.

D. An inductive device including an electrical winding having a substantially toroidal shape, at least one cylindrical magnetic component disposed about the electrical winding, and at least one sector shaped magnetic component disposed about the electrical winding.

E. An inductive device including an electrical component formed in a generally toroidal shape, the electrical component including a first primary winding, a second primary winding, a first secondary winding, and a second secondary winding, wherein the first and second secondary windings are disposed adjacent to each other, and the first primary winding is disposed on an inner circumferential portion of the toroidal shape and the second primary winding is disposed on an outer circumferential portion of the toroidal shape, and a magnetic component at least partially embracing the electrical component.

F. An inductive device having a plurality of first elongate electrical components, each of substantially cylindrical sector form, and a plurality of second elongate electrical components, each of substantially cylindrical sector form, wherein the plurality of first elongate electrical components and the plurality of second elongate electrical components are arranged to form a substantially cylindrical shape.

G. A method of forming an inductive device comprising the steps of (a) winding, onto a form, a magnetic pattern member including continuous, elongate magnetic material extending in alternating directions transverse to a winding direction of the pattern member onto the form; and (b) winding an electrical component onto the form in a winding direction transverse to said alternating directions.

H. An inductive device formed according to the method described in paragraph G above.

The foregoing and other aspects of the present invention, as well as its various features and advantages, will be more readily appreciated from the following detailed description taken in conjunction with the accompanying drawings.

### BRIEF DESCRIPTION OF THE DRAWINGS

FIGS. 1-3 are diagrams for explaining a method of making a toroidal inductive device in accordance with the present invention;

FIG. 4 diagrammatically illustrates an apparatus for implementation of the method of the invention;

FIG. 5 provides a view for explaining a variation of the method of the invention;

FIG. 6 is a view for explaining further variations of the invention;

FIGS. 7A-C illustrate exemplary means of securing completed magnetic components on an electrical core;

FIG. 8A provides a view of an embodiment having a magnetic component with a splayed outer surface;

FIG. 8B provides a diagrammatic view of an exemplary removable bobbin;

FIG. 9 provides a view of an embodiment having splayed magnetic components;

FIG. 10 provides a view of an embodiment having splayed magnetic components and non-splayed magnetic components;

FIG. 11 provides a view of an embodiment having alternating splayed and non-splayed magnetic components;

FIG. 12 provides a view of an electrical core including a straight portion to facilitate winding of a magnetic component;

FIG. 13 provides a view of an embodiment having a toroidal electrical core onto which a magnetic component having a toroidal shape has been wound;

FIG. 14 provides a view of an embodiment having a toroidal electrical core onto which two magnetic components each having a toroidal shape have been wound;

FIG. 15 provides a view of an embodiment having a toroidal electrical core onto which multiple magnetic components each having a toroidal shape have been wound;

FIG. 16 provides a view of an embodiment having an electrical core onto which a plurality of magnetic components have been wound and formed into a sector shape;

FIG. 17 shows a cross-sectional view of an exemplary electrical coil having an elongated shape;

FIG. 18 shows a perspective view of an elongate electrical coil having an essentially cylindrical sector form;

FIG. 19 shows top and end views of the coil shown in FIG. 18;

FIG. 20 provides an end view of an embodiment having cylindrical sector segments disposed to form a structure having a generally cylindrical shape;

FIG. 21 provides an end view of an embodiment having cylindrical sector shaped elongated winding segments placed into approximate position with each other and having electrical lead connections;

FIG. 22 provides an end view of an embodiment having electrical coils connected in series;

FIG. 23 provides an end view of a transformer embodiment having plural series-connected primary windings and plural series-connected secondary windings;

FIG. 24 provides an end view of a transformer having plural parallel-connected primary windings and plural parallel-connected secondary windings;

FIG. 25 provides an end-view of a transformer embodiment including elongate electrical coils and elongate electrical coils having a cylindrical sector shape;

FIG. 26 provides an a view of an embodiment having a plurality of elongate electrical coils placed together and wrapped on the outside with magnetic material;

FIG. 27 provides a view of an embodiment having electrical coil segments in place with a rotor placed at the center of the coil assemblies such that the rotor is surrounded by the electrical coil assemblage;

FIG. 28 provides a diagrammatic view of an exemplary wire material formed into a serpentine arrangement for use in a further method of the invention;

FIGS. 29 and 30 show another form of wire material that can be used in the invention;

FIG. 31 provides a diagrammatic illustration of an exemplary winding apparatus;

FIG. 32 is a side view of a magnetic material component that has been formed into a suitable arc shape to conform to an electrical coil having a generally toroidal form;

FIG. 33 is a cut-away view of a finished exemplary transformer with leads shown entering and exiting the device with portions of magnetic windings shown on the inside and outside of the annular form in accordance with the present invention;

FIG. 34 shows an outside view of the device shown in FIG. 33;

FIG. 35 shows another outside view of the device shown in FIG. 33;

FIG. 36 shows an embodiment having an elongate electrical core enveloped by a bobbin not passing through an inner opening of the electrical coil core;

FIG. 37 shows a cross sectional side view of an embodiment having multiple primary and secondary windings; and

FIG. 38 shows a cross sectional top view of the device shown in FIG. 37.

### DETAILED DESCRIPTION

The embodiments described below represent non-limiting examples of the present invention. In some instances, certain features are shown in exaggerated or enlarged form to facilitate a clearer understating of a particular embodiment.

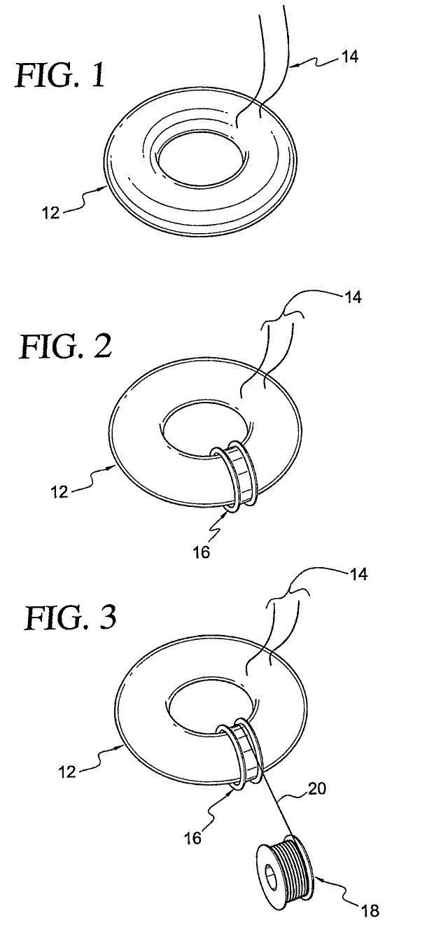

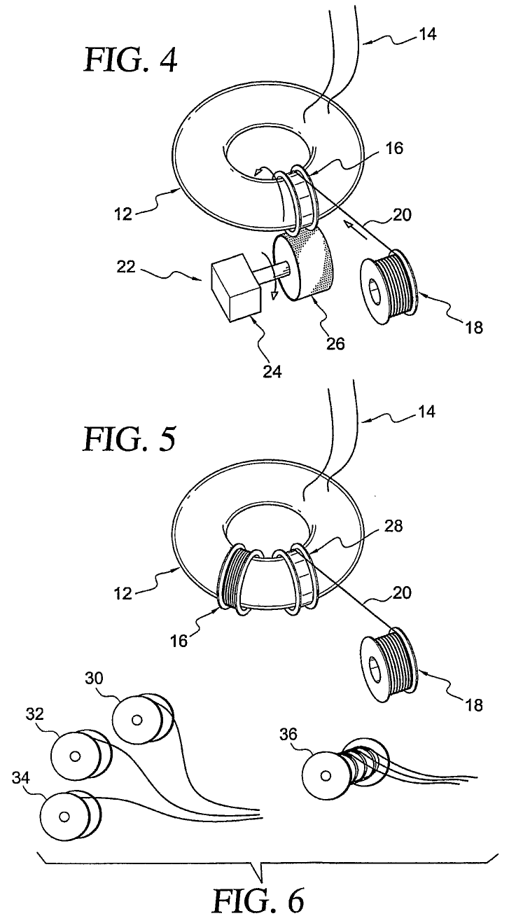

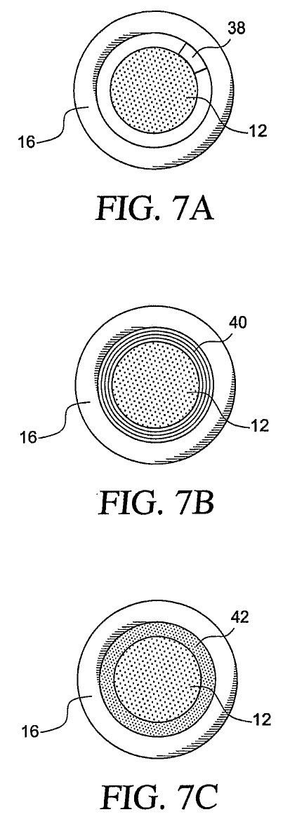

FIGS. 1-3 are diagrams for explaining a method of making a toroidal inductive device in accordance with the present invention. In particular, the method of making an inductive device can include providing a toroidal electrical core 12. The toroidal electrical core 12 can include electrical leads 14. The inductive device can be configured for use as an inductor, a choke, a transformer, or the like. The electrical core 12 can be formed of electrical wire or electrical strip, for example. The conductive material forming the electrical core 12 is preferably coated with an electrically insulating material. The toroidal shaped electrical core 12 provides a shape about which one or more magnetic components can be disposed so that the electrical core is at least partially enveloped by the magnetic components.

The electrical leads 14 can be used to connect the inductive device to another electrical device, a system or a circuit. The number of leads extending from the electrical core can depend on a number of factors, such as, the number of individual windings, or coils, that constitute the electrical core component and/or how individual windings are connected within the electrical core component. Also, the placement of the leads can be selected as desired depending upon the requirements of a particular application.

As shown in FIG. 2, the method of making an inductive device continues with the provision of a bobbin 16 disposed about the electrical coil. The bobbin 16 is fit loosely enough about the electrical core 12 so that the bobbin 16 can easily be rotated about the electrical core 12 to enable winding of a magnetic component about the electrical core 12. A lubricant such as Teflon, silicon, or other suitable lubricating agent can be applied to an outer surface of the electrical core 12 and/or an inner surface of the bobbin 16 in order to reduce friction between the bobbin 16 and the electrical core 12 and thereby reduce or prevent frictional damage to either component as a result of rotation. The lubricant may be an electrical insulator.

The bobbin 16 may be formed of plastic, fiber reinforced plastic, or other suitable material. The bobbin 16 can be made to be later removable and/or reusable, or it may become a permanent part of the inductive device. The bobbin 16 may be formed as a cylinder without shoulders, or as a cylinder with shoulders as shown. If the magnetic material being wound onto the bobbin should break, the magnetic material may simply be reattached to the bobbin and the winding can continue. Also, multiple magnetic subcomponents may be wound onto the bobbin 16. The magnetic material may include a single strand wire, multi-strand wire, a single strip, multiple strips, or a combination of the above.

FIG. 3 shows a single wire winding arrangement having a supply reel 18 of wire or strip magnetic material 20. Supply reel 18 supplies magnetic material 20 for winding onto the bobbin 16. The winding of the magnetic material 20 onto the bobbin 16 can be performed manually, automatically, or through a combination of the above.

In practice, an end of the magnetic material 20 can be attached to the bobbin 16. The bobbin 16 is then be rotated about the electrical core 12. As the bobbin 16 rotates about the electrical core 12, the magnetic material 20 is fed from the supply reel 18 and onto the bobbin 16 thereby forming a wound magnetic component about the electrical core 12.

FIG. 3 shows a beginning of winding a single wire onto the bobbin 16 as, for example, a first magnetic material sector wound onto the electrical core 12. While a single supply reel 18 is shown as carrying a single magnetic wire 20, it should be appreciated that the supply reel may carry a plurality of wires or strips. In order to increase the density of the magnetic component, the magnetic wire may include wires having different shapes and/or different sizes. For example, the magnetic wire may include round wires having two different sizes with, for example, a circumference ratio that is between 5:1 and 6:1. The magnetic wire can include wire having different cross-sectional shapes, sizes, and/or cross-sectional areas. It should be appreciated that multiple wires, or multiple strands, may be used to build an inductive device according to the method described above, and such use may require fewer rotations of the bobbin 16 and thereby contribute to the efficiency of the manufacturing process.

FIG. 4 provides a diagrammatic view of an embodiment having a source of motive force to engage the bobbin and wind the magnetic medium onto the electrical coil. In particular, in addition to the elements described above, FIG. 4 shows a bobbin rotator 22. The bobbin rotator 22 includes a drive 24 (e.g., a speed-controlled electric motor) and a bobbin drive wheel 26 attached to a rotatably driven shaft of the drive 24. In the form shown, the bobbin drive wheel 26 frictionally engages end flanges of the bobbin 16 and rotates the bobbin 16 about the electrical core 12. The magnetic material 20, having been attached to the bobbin 16 prior to rotation, is thus wound onto the bobbin 16, and thereby wound about the electrical core 12, as the bobbin 16 is rotated by the bobbin drive wheel 26. The magnetic material 20 may be attached to the bobbin 16 by any suitable means such as adhesive, adhesive tape, a fastener, etc. As the magnetic material 20 is wound onto the bobbin 16, the magnetic material 20 is unwound from the supply reel 18. The supply reel may rotate freely in response to the unwinding of the magnetic material 20, or it may rotate under power. To facilitate engagement with the bobbin end flanges, the bobbin drive wheel may have an elastic (e.g., rubber) outer surface which elastically engages the bobbin flanges.

FIG. 5 provides a view showing a winding of a second magnetic component onto the electrical coil. In particular, in addition to the elements described above, a second bobbin 28 is shown. FIG. 5 illustrates a continuation of the building process, with one completed magnetic component having been wound onto the first bobbin 16, and a second magnetic component about to be wound on the second bobbin 28. The second magnetic component can be wound in the same manner as described above.

After each bobbin has been wound with magnetic material as desired, it can be detached from the magnetic material supply, and the combined wound magnetic component and bobbin may be held in place on the electrical core by suitable means such as adhesive, adhesive tape, or an insulative wrapping material. The construction process of winding a bobbin to a desired level and then moving on to wind a next bobbin with magnetic material can continue until the electrical core is full with little or no additional room for another bobbin (i.e., the electrical core may be substantially enveloped or surrounded by bobbins/magnetic winding components) or until there is sufficient magnetic material in place for a contemplated operational characteristic.

FIG. 6 shows two means of winding multiple lengths of magnetic material onto the electrical core at the same time, drawing from multiple supply reels or from a single, common supply reel. In particular, a first means of supplying multiple wires or strips for winding onto a bobbin (or an electrical core) may include multiple spools 30, 32, 34 each supplying a single wire or strip. A second means for supplying multiple wires or strips for winding onto a bobbin (or an electrical core) may include a single supply reel 36 supplying multiple wires or strips to wind onto a bobbin (or an electrical core).

FIGS. 7A-C illustrate several exemplary techniques for securing completed magnetic components to the annular electrical core. In particular, FIG. 7A provides a diagrammatic view of an electrical core 12 (shown in section) with a bobbin 16 disposed thereabout and a spacer 38 disposed between an outer surface of the electrical core 12 and an inner surface of the bobbin 16. A plurality of such spacers may be fitted, preferably tightly, between the bobbin 16 and the electrical core 12, thus holding the bobbin in position retaining it in position about the electrical core.

FIG. 7B provides a diagrammatic view an electrical core 12 with a bobbin 16 disposed thereabout and a separate winding of magnetic material 40 disposed between an outer surface of the electrical core 12 and an inner surface of the bobbin 16. The separate winding of magnetic material 40 may include wire, strip, sheet material, or the like. Also, the magnetic material 40 may the same or different from the magnetic material wound onto the bobbin 16. The magnetic material 40 may act as a wedge or “shim” to help keep the bobbin 16 in place about the electrical core 12. For example, the magnetic material 40 may be wound onto the electrical core 12 and then the bobbin 16 may be slid along the electrical core and over the magnetic material 40.

FIG. 7C provides a diagrammatic view an electrical core 12 with a bobbin 16 disposed thereabout and an adhesive 42 disposed between an outer surface of the electrical core 12 and an inner surface of the bobbin 16. The adhesive 42 can be used to hold the bobbin 16 in place about the electrical core 12. The adhesive 42 may be a nonmagnetic adhesive or may be a magnetic adhesive constituted by an adhesive material impregnated with magnetic material such as magnetic powder or particles.

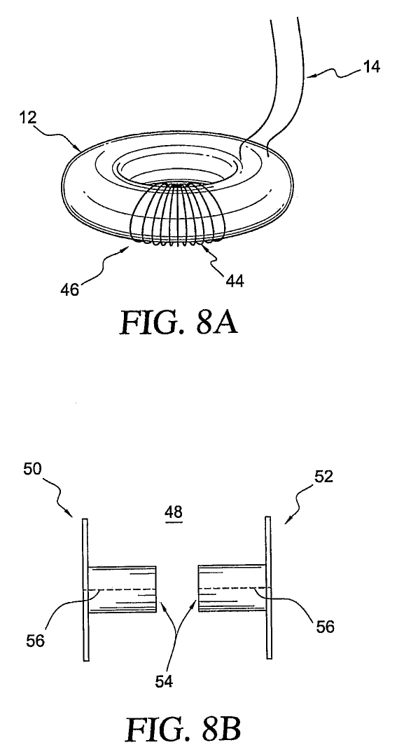

FIG. 8A provides a view of an embodiment having a splayed magnetic component 44. The splayed magnetic component 44 is splayed outwardly toward the outer diameter circumference surface 46 of the electrical core 12. The magnetic component 44 may be formed as a splayed component during winding (by guiding the magnetic material relative to the bobbin), or after winding. The splaying may be performed manually, automatically, or through a combination of the above.

By splaying the magnetic components into a generally sector shape, as shown in FIG. 8A, the outer portion of the toroidal electrical core can be more widely covered, thereby providing greater magnetic efficiency and enhanced magnetic shielding.

FIG. 8B provides a diagrammatic view of an exemplary removable bobbin. In particular, a removable bobbin 48 includes a first portion 50 and a second portion 52, separable from each other at a joint connecting inside end portions 54. The first portion 50 and the second portion 52 may be joined by snapping together interlocking members, by applying an adhesive, by using a fastener, or any other suitable means to form the aforementioned joint. Also, each of the first portion 50 and the second portion 52 includes a longitudinal joint 56 that allows the first portion 50 and the second portion 52 to each separate into respective halves. The bobbin is mounted on an electrical core by assembling the two halves of each portion 50 and 52 about the core and then joining the portions 50 and 52 together at the portions 54. The bobbin may be removed by reversing this procedure.

FIG. 9 provides a view of an embodiment having a toroidal electrical core with five splayed magnetic sector components each surrounding the electrical core 12 and having leads 14. First magnetic components 44 and one or more second magnetic components 58 (one being shown) are disposed about the electrical core 12 and circumferentially offset from each other. The magnetic components 44 and 58 may be formed in a same or different manner. For example, the magnetic components 44 may be formed by winding magnetic material onto a bobbin and splayed as described above, and the magnetic component 58 may be formed in a sector shape on a jig, then cut, removed from the jig and disposed about the electrical core so as to provide a gap in a meridional plane as described in International Patent Application Publication No. WO2005/086186, incorporated herein by reference.

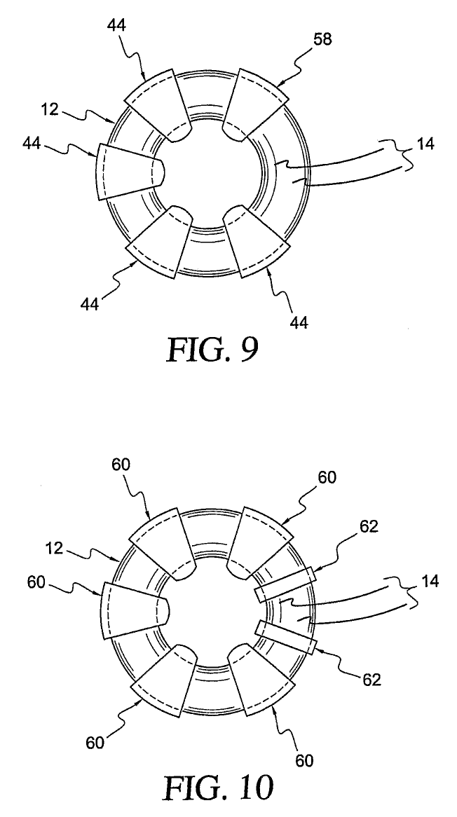

FIG. 10 provides a view of an embodiment having splayed magnetic components and non-splayed magnetic components. In particular, the inductive device of FIG. 10 includes five splayed magnetic components 60 and two non-splayed, or cylindrical, magnetic components 62, all wound by the above-described technique. The splayed magnetic components have a generally sector shape. The non-splayed magnetic components 62 can readily be wound onto the electrical core 12 after the splayed magnetic components 60 have been wound, thus accommodating the decreased amount of space available on the electrical core after the sector components 60 have been formed.

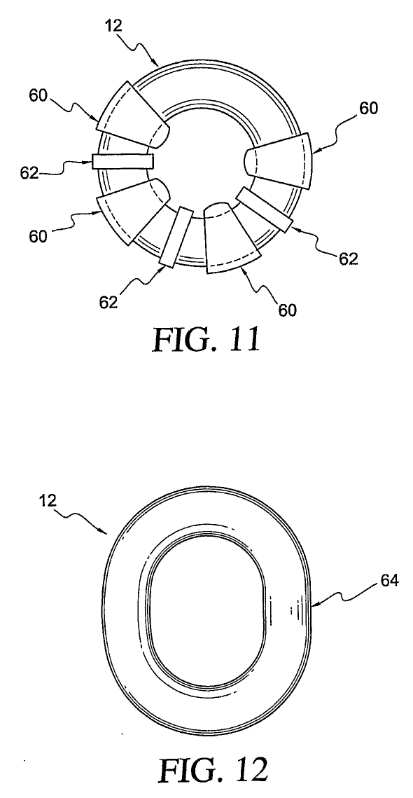

FIG. 11 provides a view of an embodiment having splayed magnetic sector components and non-splayed magnetic sector components that are interspersed. In particular, FIG. 11 shows an arrangement of alternating splayed magnetic material component sectors 60 and non-splayed magnetic components 62. Gaps in the spacing of the splayed and/or non-splayed magnetic components around the annulus can be very small or substantial, depending on the desired characteristics. For example, large gaps can be employed to facilitate cooling of the magnetic components and the electrical core.

FIG. 12 provides a view of an electrical core with a straight portion 64. The straight portion 64 is of sufficient length to allow a bobbin, disposed about the straight portion 64, to rotate easily about the electrical core 12, thus facilitating the winding of magnetic material. Once a magnetic component has been wound, it can be slid away from the straight portion 64 and along the length of the electrical core to make room for another magnetic component to be wound at the straight portion.

The straight portion 64 may be formed during winding of the electrical core 12, or after winding of the electrical core 12, and it may be permanent or temporary. In the case of a temporary straight portion, the straight portion may be returned to a rounded shape after winding of the magnetic components thereon is complete.

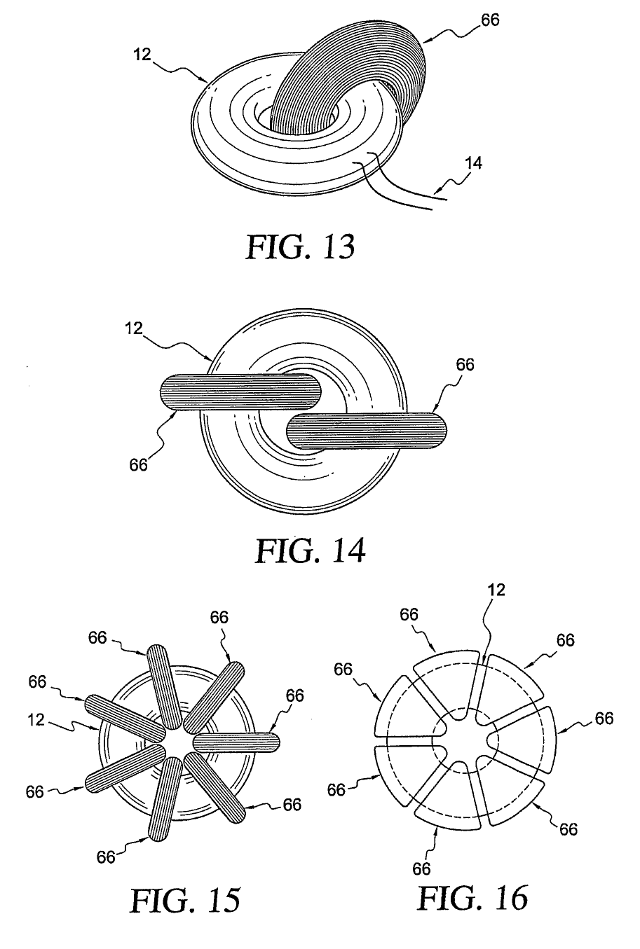

FIG. 13 provides a view of an embodiment having a toroidal electrical core onto which a magnetic component having a toroidal shape has been wound. In particular, the inductive device of FIG. 13 includes an electrical core 12, leads 14 connected to the electrical core, and a magnetic component 66 wound about the electrical core 12 in the manner described above. The internal hole of the electrical coil is substantially filled by the magnetic component 66.

FIG. 14 provides a view of an embodiment having a toroidal electrical core onto which two magnetic components 66 each having a toroidal shape have been wound in the manner described above. The inductive device of FIG. 14 includes an electrical core 12 (with leads not shown) and two magnetic components 66 each wound about the electrical core 12. The two magnetic components 66 are disposed about generally opposite side portions of the electrical core 12.

FIG. 15 provides a view of an embodiment having a toroidal electrical core onto which a plurality of magnetic components 66 each having a toroidal shape have been wound as previously described. The inductive device of FIG. 15 includes an electrical core 12 (with leads not shown) and multiple (3 or more, here 7) magnetic components 66 wound about the electrical core 12. Each of the magnetic components 66 disposed about the electrical core 12 is circumferentially offset from the others.

FIG. 16 provides a view of an embodiment having an electrical core 12 with a plurality of magnetic components 66 disposed thereabout. The plurality of magnetic components are circumferentially offset from each other, and formed by winding onto the electrical core 12 with a bobbin as described above. The wound magnetic components provide an effective magnetic gap (specifically, a distributed gap) by virtue of the fact that the winding follows a non-circular path whereas magnetic flux is circular and is thus forced to “jump” between successive turns of the winding as they traverse the circular flux path.

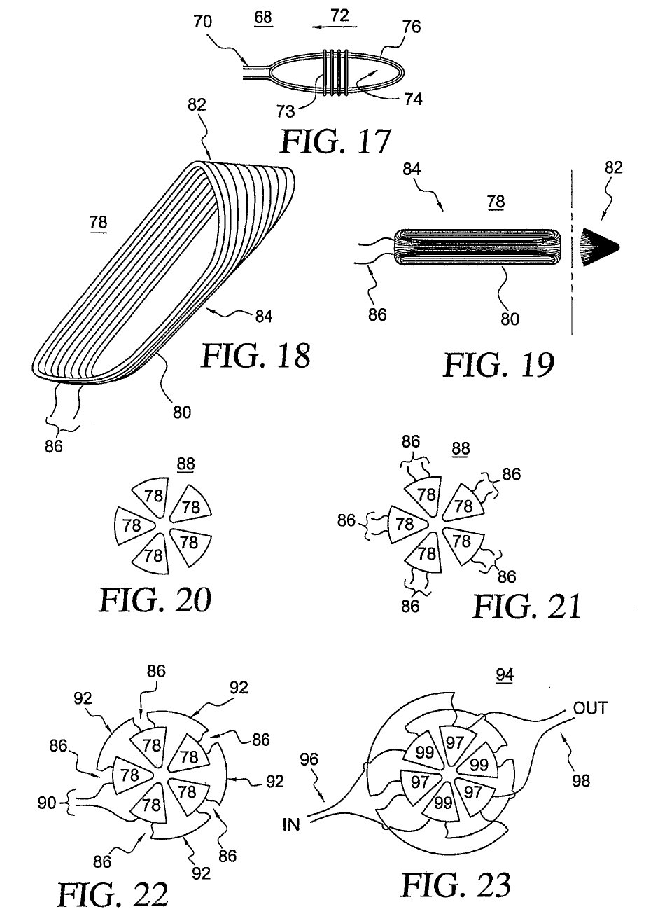

FIG. 17 is a side view of an exemplary inductive device 68 having an electrical coil 76 formed in a generally elongated toroidal configuration and leads 70 connected to the electrical coil. The electrical coil 76 is elongated along an elongation direction indicated by arrow 72. The inductive device 68 also includes a magnetic component 73 wound about the electrical coil 76 in a winding direction transverse to the electrical winding direction of the electrical coil 76 and without passing through an inner opening 74 of the electrical coil 76. Optionally, additional magnetic material, such as wire, strip, powder, magnetic adhesive, or the like, may be disposed in the inner opening 74.

FIG. 18 shows an elongated electrical coil having an essentially cylindrical sector form. In particular, a cylindrical sector 78 electrical component includes an electric winding 80 having a sector shaped end portion 82 and elongated sides 84. The electric winding 80 is connected via electrical leads 86. The cylindrical sector 78 can be formed by winding electrical wire onto a jig. Adhesive material may be used to bind the electrical wire during or after formation of the cylindrical sector 78 to maintain the desired form. Also, tape or other binding material may be used to secure the cylindrical sector 78 in its wound configuration.

It should be appreciated that magnetic material in the form of a wire, strip, powder material, or the like, could be placed within an inner area formed by loops of the electrical coil 78 either as a continuous component or in sections.

FIG. 19 shows top and end views of the coil shown in FIG. 18. In particular, the cylindrical sector 78 electrical component includes an electric winding 80 having a sector shaped end portion 82 and elongated sides 84. The electric winding 80 is connected via electrical leads 86. The sector shaped configuration of electrical component 78 permits multiple cylindrical sector shaped electrical components to be arranged to form an overall cylindrical structure.

FIG. 20 provides an end view of an embodiment having cylindrical sector components disposed to form a structure having a generally cylindrical shape. In FIG. 20, an inductive device 88 includes a plurality of elongate electrical components 78, each of a substantially cylindrical sector form. The plurality of elongate electrical components 78 are arranged to form a substantially cylindrical structure. The spacing between adjacent components may be filled with an insulative adhesive or potting material to assure structural integrity of the assembled components. Although the components are shown spaced from each other, such spacing is not strictly necessary so long as adjacent sides of the components are not in electrical contact. For this purpose, any suitable insulating material may be disposed between the components, or the windings may be coated with insulation. Also, magnetic material in the form of wire, narrow strip, powder material, or the like, could be installed in a center area of the device defined by the portions of the cylindrical sectors (or wedges) where they converge in the middle.

FIG. 21 provides an end view of an embodiment of similar cylindrical sector shaped elongated winding segments 78 placed into approximate position with each other and having electrical lead connections 86.

In practice, the electrical components 78 can be connected in various ways, such as individually, in series, in parallel, or in group arrangements as may be suitable for a contemplated use of the embodiment. FIG. 22 shows an arrangement in which the electrical components 78 are connected in series. FIG. 23 provides an end view of a transformer arrangement having a primary and a secondary, each comprised of a group of cylindrical sector shaped electrical winding components connected in a series configuration. In particular, transformer 94 includes input leads 96 connected to a group of series-connected elongate electrical components 99 forming the primary, and output leads 98 connected to a group of series-connected elongate electrical components 97 forming the secondary. Each of the first and second elongate electrical components 97, 99 is of substantially cylindrical sector form, and the elongate electrical components are collectively arranged to form a substantially cylindrical shape.

In operation, electrical energy provided to the primary leads 96 is transformed by the inductive coupling between the primary electrical coils 99 and the secondary electrical coils 97 and output via leads 98.

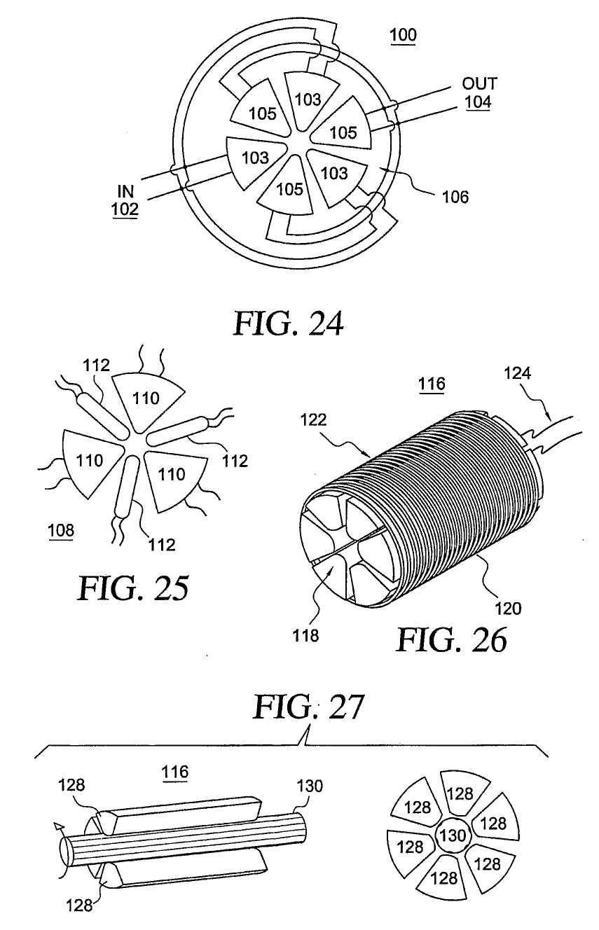

FIG. 24 provides an end view of a transformer arrangement having a primary and a secondary, each comprised of a group of cylindrical sector shaped electrical winding components connected in a series configuration. In particular, transformer 100 includes input leads 102 connected to a group of parallel-connected elongate electrical components 103 forming the primary, and output leads 104 connected to a group of parallel-connected elongate electrical components 105 forming the secondary. Each of the first and second elongate electrical components 103, 105 is of substantially cylindrical sector form, and the elongate electrical components are collectively arranged to form a substantially cylindrical shape.

FIG. 25 provides an end-view of another transformer arrangement combining cylindrical sector shaped coils 110 and elongated toroidal coils 112. The coils 110 and 112 are similar to the electrical coils shown in FIGS. 18 and 17, respectively.

FIG. 26 provides a view of an embodiment having a cylindrical arrangement of electrical coil components (as exemplified in any of FIGS. 20-25) wrapped on the outside with magnetic material. The magnetic component 120 may be formed of magnetic wire, magnetic strip, or other suitable magnetic material. Magnetic wire or strip material would preferably be wound transverse to the electrical windings of the cylindrical core 118. The cylindrical core can be connected to a circuit via electrical leads 124 (only two of which are shown in the drawing). It should be appreciated that the number of leads may vary depending on a contemplated use of the embodiment and other factors such as number of electrical windings within the device.

The magnetic component 120 serves to contain the magnetic flux generated within the cylindrical core 118 and direct the flux along a path about the cylindrical core 118. Inductive coupling between the individual coils of the cylindrical core is provided by the outer magnetic component and air (or magnetic material, if desired) inside the cylindrical core 118.

FIG. 27 provides a view of an embodiment having electrical coil components with a rotor placed at the center of the assembled coil components such that the rotor is surrounded by the electrical coil assemblage. In particular, an electric motor 126 includes stator coils 128 and a rotor 130. The stator coils 128 can include an inductive device 68, a cylindrical sector 78, or a combination of the two. The rotor can take the form of a shaft having grooves formed along its length or any other suitable for that will provide electromagnetic interaction with the stator to effect rotation of the rotor. Of course, generator action may also be provided, as will readily be understood by those skilled in the art. Other embodiments can provide linear motion.

The assembled stator coils 128 may be wrapped on the outside with magnetic material, such as wire or strip material. Also, the stator coils 128 may be held together using potting material, clamps, a tube made of ceramic or other suitable nonmetallic material, etc.

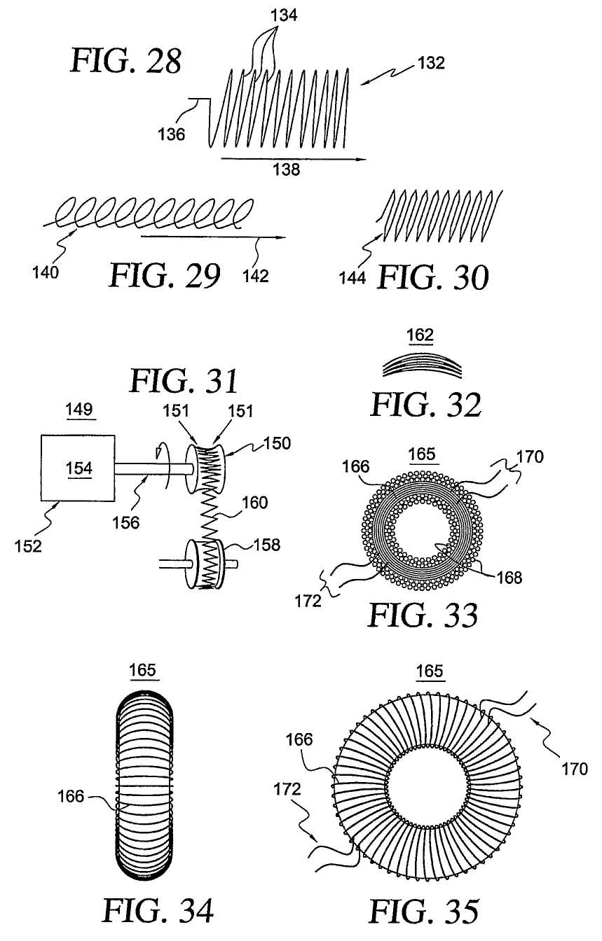

FIG. 28 provides a diagrammatic view of a magnetic pattern member 132 composed of magnetic wire formed into a serpentine arrangement. Such a pattern member and one or more toroidal electrical components can be wound in the same direction on a common form, thus facilitating the manufacture of a toroidal inductive device with the magnetic pattern member serving as a magnetic component of the device. The magnetic pattern member 132 is formed such that adjacent lengths 134 of a continuous, elongate magnetic material 136 extend in alternating directions transverse to a longitudinal direction 138 of the pattern member. The continuous material may be constituted of magnetic wire or other elongate magnetic material, such as magnetic strip material, and may be held in shape by adhesive material, for example, such that the pattern member essentially becomes a strip-like material having lengths 134 running transverse to the longitudinal direction of the “strip.”

FIGS. 29-30 illustrate another technique of forming a pattern member from magnetic wire. In particular, a helical coil 140 of magnetic wire is first formed along a forming direction 142. Next the coil 140 is flattened, and optionally compressed longitudinally, to produce a substantially flat member of magnetic material 144, where adjacent portions of material forming the member extend substantially transversely to the forming direction 142. Like member 132, the member 144 may be held in shape by adhesive material or any other suitable means.

FIG. 31 provides a diagrammatic illustration of an exemplary inductive device winding apparatus 149. The apparatus 149 includes a mandrel 150, magnetic material shaping devices (indicated diagrammatically by arrows 151), a winding apparatus 152 having a motor 154 and a shaft 156, a supply rail 158, and magnetic material 160 supplied from the supply reel. Magnetic material 160 is constituted by a magnetic pattern member formed as shown in FIGS. 28-30.

To form a magnetic component, magnetic material 160 is attached to the mandrel 150 and winding apparatus 152 is operated to rotate mandrel 150 to wind the magnetic material 160 onto the mandrel. The magnetic strip is advanced lengthwise as it is wound onto the mandrel 150, its adjacent portions 134 or the like extending transversely to the winding direction. The surface of mandrel 150 can be of concave form, as shown, corresponding to the inner surface of the desired toroidal shape of a finished toroidal inductive device.

After winding a desired length of the magnetic member 160 onto the mandrel 150, one or more coils of electrical wire may be wound over the magnetic material present on the mandrel to form a toroidal electrical core. Finally, one or more layers of magnetic material 160 can be wound over the electrical winding(s). As the further magnetic material is being wound about the mandrel 150, the magnetic material shaping devices 151 can shape and form the magnetic material so as to embrace and conform to the underlying material on the mandrel. The shaping devices 151 may be simple manual tools configured to press the advancing magnetic material so as to conform with the outer surface of the underlying material on the mandrel, or they may be automatically controlled shaping tools such as computer-controlled shaping roller devices. It will be appreciated that a shaping tool may also be employed during the first magnetic material winding step, before winding the electrical core. FIG. 32 is a diagrammatic view illustrating a magnetic pattern member 162 that has been shaped into an arcuate form to conform to an electrical coil having a generally toroidal form.

According to another approach, the magnetic pattern member could be formed “on the fly” as it is being fed from a spool of wire to the mandrel 150.

FIG. 33 is a diagrammatic cut-away view of a toroidal transformer 165 formed by the technique described in connection with FIG. 31. The transformer 165 includes a magnetic component 166 composed of inner and outer magnetic pattern members wound on a mandrel and shaped to conform to an intermediate electrical core also wound on the mandrel, as described above. Leads 170 and 172 connect to windings of the electrical core 168. FIG. 34 is a diagram of the transformer taken from the side. FIG. 35 is a corresponding plan view diagram.

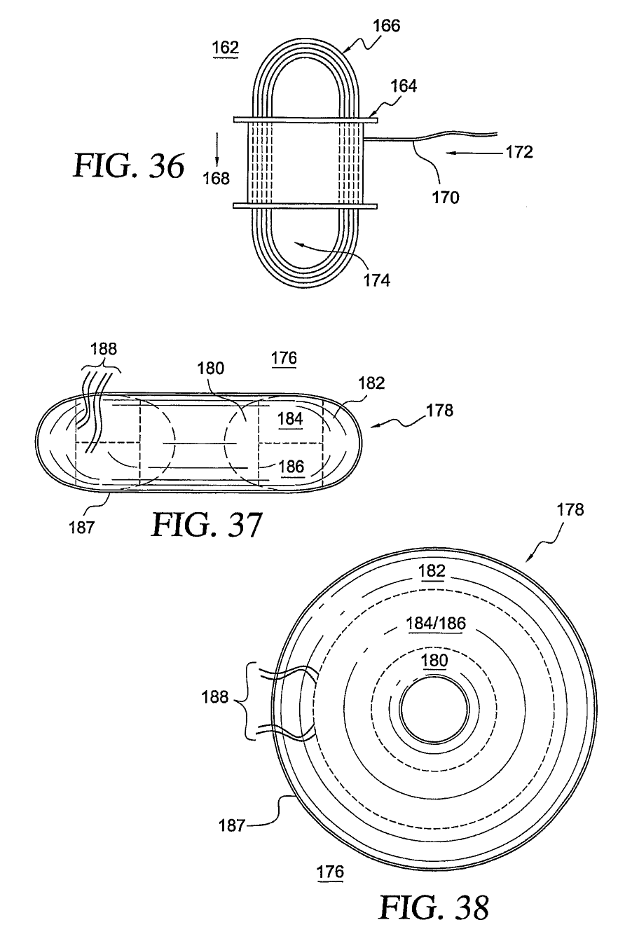

FIG. 36 depicts the use of a bobbin 164 disposed about an elongated electrical core 166 for winding a magnetic material about the core at its outer cross-dimension. The electrical core 166 is elongated in an elongation direction 168 and may include one or more electrical windings. Magnetic material (e.g., wire) 170 is wound onto the bobbin 164 in a winding direction 172 transverse to the elongation direction 168 of the core (i.e., transverse to the lengthwise direction of the electrical core wires within the bobbin). An area 174 is defined by an inside surface of the elongated electrical core 166. As shown in FIG. 36, an entire outer cross-dimension of the core 166 is received within the bobbin 164 (the bobbin 164 does not pass through the area 174 of the inner core opening), whereby the resulting wound structure will resemble that shown in FIG. 17. The bobbin may be retained as part of the finished device or removed, as described in connection with earlier embodiments.

FIGS. 37 and 38 show two views of an exemplary inductive device having heavy current elements in the center with high-tension elements on both sides. In particular, inductive device 176 having a toroidal shape 178 includes a first primary winding 180, a second primary winding 182, a first secondary winding 184, a second secondary winding 186, and leads 188.

The first and second secondary windings (184 and 186) are disposed adjacent to each other and in the center of the torus. The first primary winding 180 is disposed on an inner circumferential portion of the toroidal shape and the second primary winding 182 is disposed on an outer circumferential portion of the toroidal shape. The inductive device 176 may also include a magnetic component 187 wrapped about the composite core composed of the primary and secondary windings. Alternatively, magnetic components may be wound onto the electrical core using a bobbin in the manner described in connection with FIGS. 1-12.

While this invention has been described in conjunction with a number of embodiments, it will be apparent to those skilled in the art that many alternatives, modifications and variations are possible without departing from the principles and spirit of the invention.

1-24. (canceled)

25. An inductive device, comprising:
an electrical component formed in a generally toroidal shape, the electrical component including a first primary winding, a second primary winding, a first secondary winding, and a second secondary winding, wherein the first and second secondary windings are disposed adjacent to each other, and the first primary winding is disposed on an inner circumferential portion of the toroidal shape and the second primary winding is disposed on an outer circumferential portion of the toroidal shape; and
a magnetic component at least partially embracing the electrical component.

26. The inductive device of claim 25, wherein the first secondary winding and the second secondary winding are each formed of strip material.

27. The inductive device of claim 26, wherein the strip material includes aluminum.

28. An inductive device, comprising:
an electrical coil formed in a generally elongated toroidal configuration; and
a magnetic component disposed about the electrical coil along an elongation direction and transverse to an electrical winding direction, the magnetic component at least partially embracing the electrical coil.

29. The inductive device of claim 28, further comprising magnetic material disposed in an area defined by an inner surface of the electrical coil.

30. The inductive device of claim 28, wherein the magnetic component includes magnetic wire or strip material.

31. An inductive device, comprising:
a plurality of first elongate electrical components, each of substantially cylindrical sector form; and
a plurality of second elongate electrical components, each of substantially cylindrical sector form, wherein the plurality of first elongate electrical components and the plurality of second elongate electrical components are arranged to form a substantially cylindrical shape.

32. The inductive device of claim 31, wherein the plurality of first elongate electrical components and the plurality of second elongate electrical components are disposed alternately.

33. The inductive device of claim 31, further comprising a magnetic member formed about the substantially cylindrical shape along an elongation direction, the magnetic member formed in a transverse direction to a winding direction of the first and second elongate electrical components.

34. The inductive device of claim 31, wherein each of the plurality of first elongate electrical components are connected in series to form a primary electrical member, and each of the plurality of second elongate electrical components are connected in series to form a secondary electrical member.

35. The inductive device of claim 31, wherein each of the plurality of first elongate electrical components and each of the plurality of second elongate electrical components are connected together in series to form a single electrical member.

36. The inductive device of claim 31, wherein each of the plurality of first elongate electrical components and each of the plurality of second elongate electrical components is devoid of magnetic material in an area defined by an inner surface of each respective electrical coil.

37. The inductive device of claim 31, wherein at least one of the plurality of first elongate electrical components or at least one of the plurality of second elongate electrical components includes magnetic material disposed in an area defined by an inner surface of the respective electrical coil.

38. The inductive device of claim 31, wherein the inductive device includes an electric motor comprising:
a rotor; and
a stator disposed about the rotor and formed by the plurality of first elongate electrical components and the plurality of second elongate electrical components, the stator having a magnetic component at least partially embracing the cylinder along an elongation direction of the cylinder.

39. The inductive device of claim 38, wherein the electric motor is a single-phase electric motor.

40. The inductive device of claim 38, wherein the electric motor is a multi-phase electric motor.

41. The inductive device of claim 38, wherein the magnetic component includes magnetic wire or strip material.

42. A method of forming an inductive device, comprising the steps of:
(a) winding, onto a form, a magnetic pattern member including continuous, elongate magnetic material extending in alternating directions transverse to a winding direction of the pattern member onto the form; and
(b) winding an electrical component onto the form in a winding direction transverse to said alternating directions.

43. The method of claim 42, wherein the magnetic pattern member includes serpentine magnetic wire.

44. The method of claim 42, wherein the magnetic pattern member includes a flattened magnetic wire coil.

45. The method of claim 42, wherein step (b) is performed after step (a), and further comprising a step of:
(c) winding a second said magnetic pattern member onto the form over the electrical component.

46. The method of claim 42, wherein step (b) is performed before step (a).

47. The method according to claim 43, wherein the magnetic pattern member is formed prior to step (a).

48. The method according to claim 43, wherein the magnetic pattern member is formed during to step (a).

49. (canceled)

50. The method according to claim 44, wherein the magnetic pattern member is formed prior to step (a).

51. The method according to claim 44, wherein the magnetic pattern member is formed during to step (a).
